(19) United States
(12) Patent Application Publication
(10) Pub. No.: US 2026/0030840 A1
(43) Pub. Date: Jan. 29, 2026

(54) HARDWARE ACCELERATOR FOR GAUSSIAN RENDERING AND RECONSTRUCTION

(71) Applicant: NVIDIA Corp., Santa Clara, CA (US)

(72) Inventors: Sixu Li, Atlanta, GA (US); Benjamin Andrew Keller, Oakland, CA (US); Brucek Kurdo Khailany, Rollingwood, TX (US)

(73) Assignee: NVIDIA Corp., Santa Clara, CA (US)

(21) Appl. No.: 19/243,247

(22) Filed: Jun. 19, 2025

Related U.S. Application Data
(60) Provisional application No. 63/676,100, filed on Jul. 26, 2024.

(51) Int. Cl. G06T 17/00; G06T 1/20

(52) U.S. Cl. CPC G06T 17/00; G06T 1/20

(57) ABSTRACT

Rasterizers that include multiple processing elements each including logic specific to triangle rasterization, logic specific to Gaussian rasterization, and logic common to both of the triangle rasterization and the Gaussian rasterization. The rasterizer further includes a runtime-activated selector to activate either the logic specific to triangle rasterization or the logic specific to Gaussian rasterization.

### CROSS-REFERENCE TO RELATED APPLICATIONS

This application claims priority and benefit under 35 U.S.C. 119 (e) to U.S. Application Ser. No. 63/676,100, “Hardware Accelerator for Gaussian Rendering and Reconstruction”, filed on Jul. 26, 2024, the contents of which are incorporated herein by reference in their entirety.

### BACKGROUND

Neural rendering combines deep learning with computer graphics to generate photorealistic visual information. It enables three-dimensional (3D) reconstruction from a set of images captured by a camera, and provides control over scene parameters such as lighting, camera position, and geometry.

3D Gaussian splatting, and example of which is depicted in FIG. 1, is one approach to neural rendering. 3D Gaussian splatting represents scenes explicitly using learnable 3D gaussian balls. 3D Gaussian splatting may be utilized in applications such as generation of avatars, self-driving simulation, and Simultaneous Localization and Mapping systems.

Efficiently accelerating 3D Gaussian splatting in computer hardware remains a challenge. Conventionally, 3D Gaussian splatting is computed on graphics processing units (GPUs), but current edge GPU mechanisms may not achieve desired rates of real-time rendering (e.g., 60 FPS) or deep network training.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a 3D Gaussian splatting process at a high level.

FIG. 2A-FIG. 2C depict example rendering pipelines for triangular meshes and Gaussians.

FIG. 3 depicts a graphics processing unit at a high level, in accordance with one embodiment.

FIG. 4 depicts a graphics processing unit rasterizer structure in more detail, in accordance with one embodiment.

FIG. 5A illustrates an aspect of the subject matter in accordance with one embodiment.

FIG. 5B illustrates an aspect of the subject matter in accordance with one embodiment.

FIG. 6 an adder tree utilized inside a rasterizer, in accordance with one embodiment.

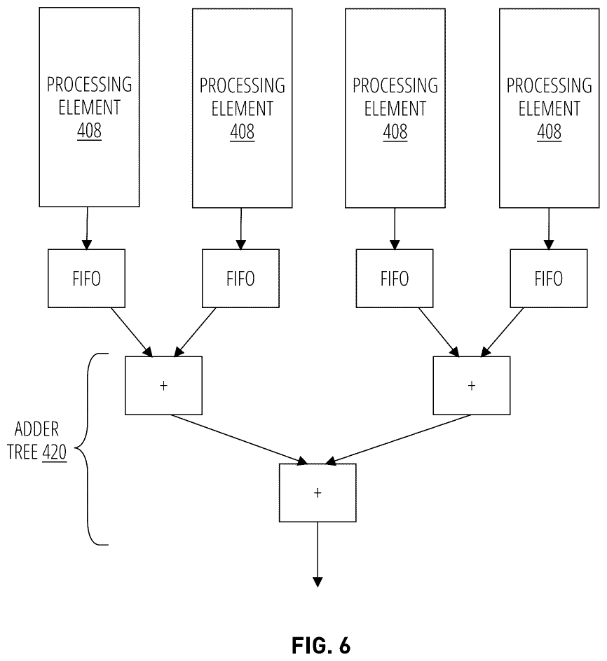

FIG. 7 depicts a parallel processing unit in accordance with one embodiment.

FIG. 8 depicts a general processing cluster in accordance with one embodiment.

FIG. 9 depicts a memory partition unit in accordance with one embodiment.

FIG. 10 depicts a streaming multiprocessor in accordance with one embodiment.

FIG. 11 depicts a processing system in accordance with one embodiment.

FIG. 12 depicts an exemplary processing system in accordance with another embodiment.

FIG. 13 depicts a graphics processing pipeline in accordance with one embodiment.

### DETAILED DESCRIPTION

Conventional mechanisms to accelerate 3D Gaussian Splatting and similar rendering pipelines typically utilize dedicated hardware accelerators. While these specialized units can provide performance benefits, they require exclusive hardware resources and often lead to increased system complexity and cost. Moreover, the integration of dedicated accelerators may not be feasible for all computing platforms, especially those with stringent area and power constraints such as edge devices, e.g., personal computers, smartphones, VR/MR/AR (virtual reality, mixed reality, and augmented reality) headsets and such.

Modern graphics processing units (GPUs) are often already equipped with optimized fixed-function hardware (rasterizers) for accelerating the rendering of triangle meshes. The disclosed mechanisms leverage these inherent resources to accelerate 3DGS rendering with reduced additional silicon overhead compared to dedicated 3DGS hardware units.

The disclosed mechanisms utilize enhancements to the rasterizer for triangle meshes within GPUs to accelerate 3DGS rendering. The disclosed mechanisms enable the efficient execution of the dominant operator in the 3DGS rendering pipeline while preserving the original capabilities for standard triangle mesh rendering. This design ensures compatibility with existing GPU architectures and minimizes disruptions to conventional workflows.

Critical-path operators involved in 3D Gaussian splatting share similarities with conventional triangle rendering pipeline, for which hardware acceleration pipelines exist in some GPU's triangle rasterizers.

Disclosed herein are enhanced rasterizers that accelerate the dominant operator in 3DGS rendering pipelines while maintaining the functionality for standard triangle mesh rendering tasks. The disclosed rasterizer enhancements may enable an order of magnitude in the speed and energy for the dominant 3DGS operator over conventional 3DGS rendering pipelines. The additional circuit area overhead incurred by the enhanced rasterizer may be in low double digits over conventional triangle mesh rasterizers.

The disclosed mechanisms may augments the computing units of a conventional graphics processing unit to alleviate performance bottlenecks that occur during 3D Gaussian splatting computations. Some of the additional silicon area that would be required to utilize dedicated accelerators for this purpose may be avoided.

In 3D Gaussian splatting mechanisms, scenes are modeled as collections of elliptical 3D Gaussian balls. Each Gaussian ball is characterized by a 3D Gaussian probability density function and an associated color vector. The rendering process distributes colors over the regions covered by the Gaussians' probability densities, collectively forming the complete scene. Rendering an image from a specific viewpoint using this representation involves three main stages.

The first stage of 3DGS rendering involves projecting the 3D Gaussian balls onto a 2D pixel plane according to the viewpoint position and angle, converting the color vector of each Gaussian to a pixel color format (e.g., red-green-blue, RBG) based on the viewpoint parameters, and computing the depth from the pixel plane of each 3D Gaussian ball relative to the given viewpoint. This stage transforms the 3D representation into a set of 2D Gaussian distributions (splats) on the pixel plane, each characterized by an opacity function o, an assigned pixel color c, a depth value d, a covariance matrix Σ representing the 2D Gaussian probability distribution, and a center point u.

In the second stage, the Gaussian splats are depth sorted. Due to potential overlap, each pixel may be influenced by multiple 2D Gaussians. The rendering order impacts their visibility since 2D Gaussians rendered earlier can obscure those rendered later. To maintain correct occlusion relationships and ensure visual consistency, the 2D Gaussians are sorted by their depth values. This depth-based sorting ensures that Gaussians nearer to the viewing position are rendered first, preserving proper occlusion handling.

The third stage, the color of each Gaussian splat is applied to any pixels that it covers, based on opacity and Gaussian probability, and follows the depth order determined in stage two. For each Gaussian that covers a specific pixel, the density αP, i is determined according to

$$α P , i = {o}_{i} {e}^{- \frac{1}{2} {( P - {μ}_{i} )}^{T} {{\sum }_{i}}^{- 1} ( P - {μ}_{i} )}$$

where P represents the pixel coordinate, i is the index of the Gaussian splat, and oᵢ is the opacity of the Gaussian splat. This density determines the contribution of the Gaussian splat to the pixel. Once the density αP, i is determined, the color contributions of the n Gaussian splats that cover the particular pixel, at least partially, are accumulated according to

$${ℂ}_{p} = \sum {T}_{P , i} {α}_{P , i} {c}_{i} , i = 1 to n$$

The term

$${T}_{P , i} = {\prod }_{j = 1}^{i - 1} ( 1 - {α}_{P , j} )$$

represents the accumulated density of all previously applied Gaussians splats at the pixel, accounting for the occlusion effects from preceding Gaussians. This ensures that only visible portions of overlapping Gaussian spats contribute to the final rendered color.

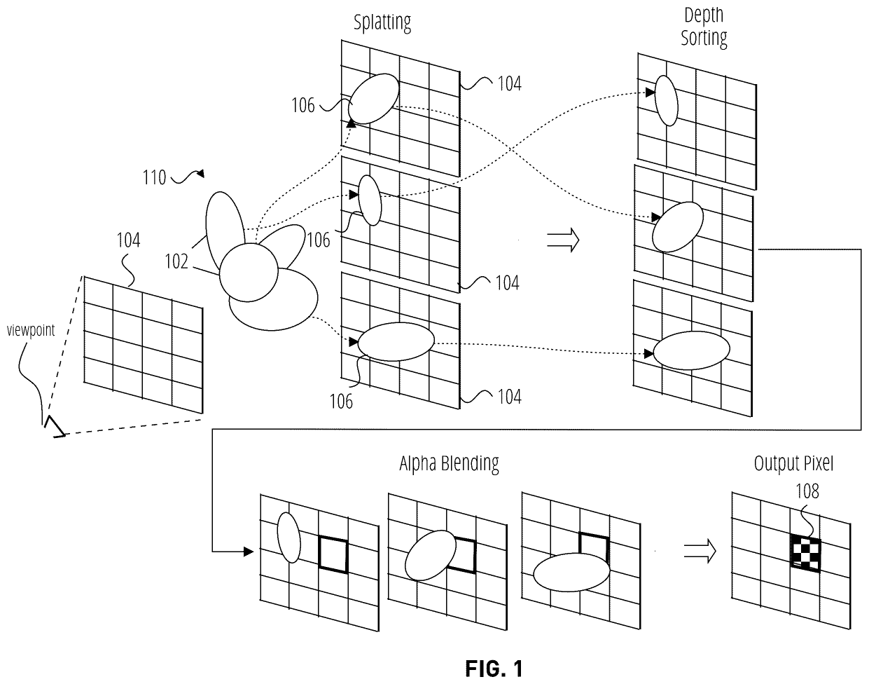

FIG. 1 depicts an overview of a 3D Gaussian splatting pipeline. A scene representation 110 is modeled as a set of 3D Gaussian balls 102, viewed from a specific viewpoint and projected onto a 2D pixel plane 104, resulting in 2D Gaussian distributions 106 on the pixel plane 104. The 2D Gaussian distributions 106 are ordered by depth to ensure the correct rendering sequence and to process occlusion settings properly. Colors for each pixel are calculated based on the color settings for the 2D Gaussian distributions 106 overlapping each pixel location. Colors are accumulated (e.g., using alpha blending) to determine the output pixel 108 colors.

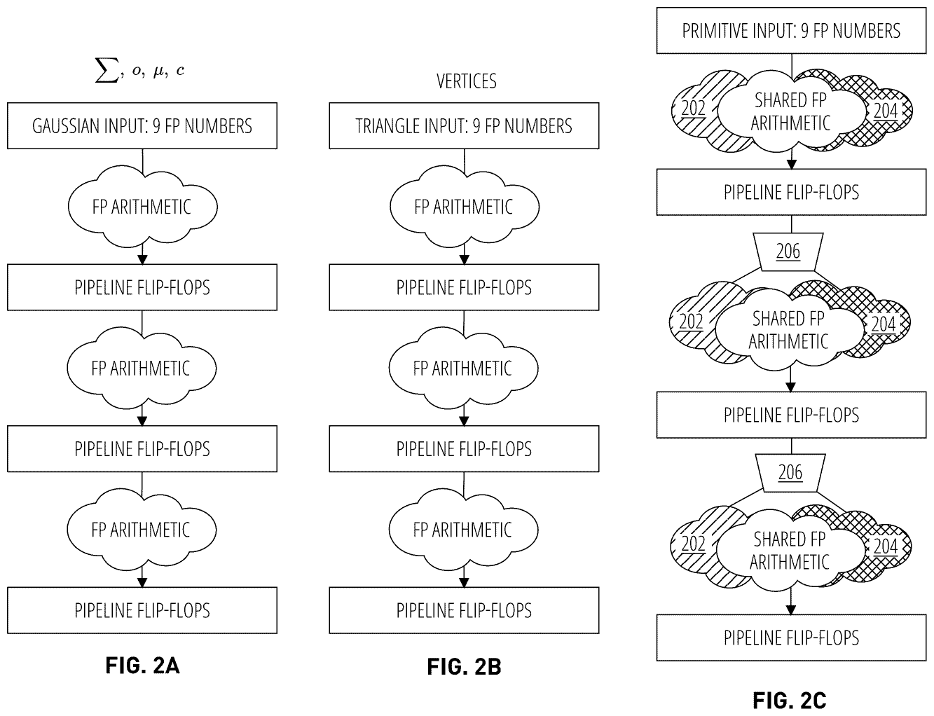

FIG. 2A-FIG. 2C depict example rendering pipelines for triangular meshes and Gaussians. Rasterizing triangles and rasterizing Gaussians share some common operations. Both involve traversing all primitives (triangles or Gaussians) for each pixel, computing a factor for the primitive-pixel pairs, and applying the factor to the pixel. FIG. 2A depicts a simplified pipeline for a Gaussian rasterizer. FIG. 2B depicts a simplified pipeline for a triangle rasterizer. Both rasterizers utilize floating point (FP) arithmetic stages and with pipeline flip-flops. A simplified depiction of a dual-purpose reconfigurable rasterizer pipeline is depicted in FIG. 2C. The dual-purpose rasterizer comprises floating point arithmetic logic shared by both Gaussian and triangle rasterizers, and runtime-selectable Gaussian rasterizing logic 202 and triangle rasterizing logic 204, specific to either Gaussian or triangular rasterization, respectively.

The data path through the pipelines may be configured via runtime switches 206 to activate either the triangle rasterizing logic 204 or the Gaussian rasterizing logic 202. Configuring the runtime switches 206 within the data pipelines provides support for processing mixed primitive sequences rather than requiring the sequence to consist exclusively of either triangles or Gaussians.

Triangle rasterization mechanisms determine if a pixel lies within a triangular boundary. In contrast, 3DGS requires calculating 2D Gaussian probability distributions to assess the coverage. This distinction leads to modifications to the detection algorithm to accommodate elliptical shapes rather than triangles.

Additionally, for triangle mesh rasterization, the reduction mechanism utilizes a minimum-depth selection to determine which primitive's parameters to apply to each pixel, whereas 3D Gaussian Splatting aggregates color contributions from multiple overlapping Gaussians. The Gaussian mechanism increases the complexity of the reduction function, because overlapping Gaussians contribute to pixel color based on their calculated densities and occlusion effects.

A dominant difference between triangle mesh rasterization and Gaussian rasterization arises from the factor computation for primitive-pixel pairs. Determination of these factors involves only multiplication and addition, enabling the reuse of hardware computation units for both tasks.

Both rasterization mechanisms utilize identical input and output parameter sizes (nine floating point parameters) and follow a similar procedure of initializing pixel storage and then applying primitives to each pixel. Due to this shared I/O width and access pattern, the memory interface of conventional triangle rasterizers may also be applied for Gaussian rasterization. Both rasterizers primarily utilize multipliers and adders to carry out core tasks. The disclosed mechanisms utilize this overlap in a reconfigurable hardware pipeline supporting both triangle and Gaussian primitives with the same hardware resources.

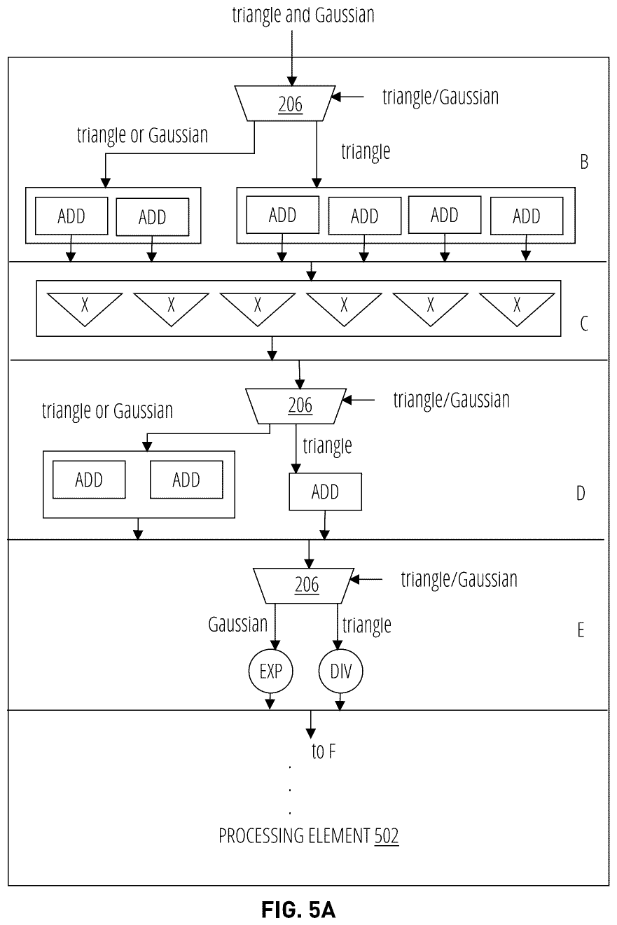

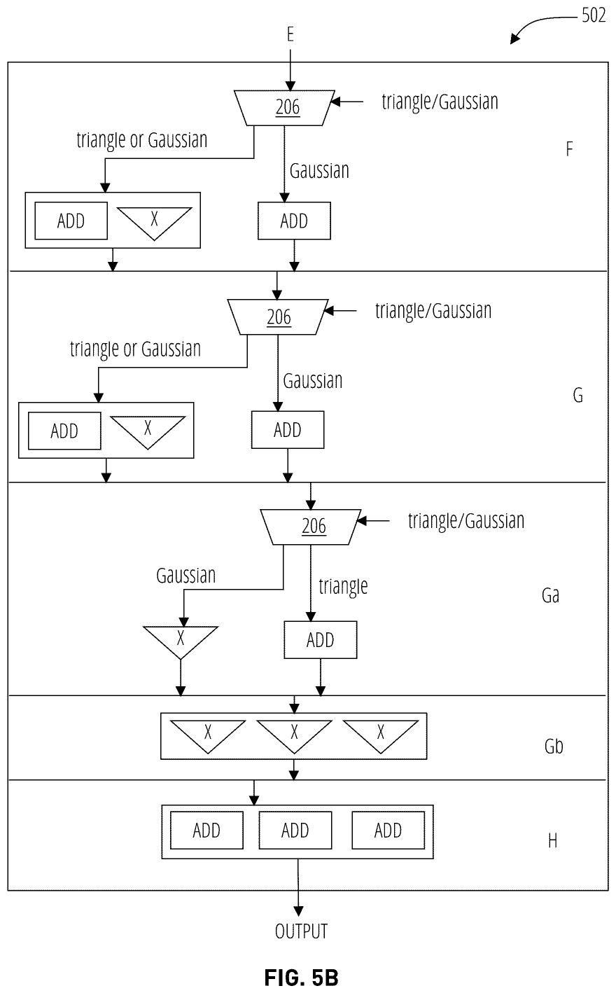

An example of shared resource utilization in a processing element hardware pipeline is provided in Table 1 below and in FIG. 5A and FIG. 5B. Other embodiments may utilize variations of this pipeline architecture (e.g., variations of the processing performed on different levels) without departing from the scope of the disclosed mechanisms.

TABLE 1
COMPUTATIONAL PRIMITIVES FOR RASTERIZATION

| Stage | Triangle Rasterization | Gaussian Rasterization |
|---|---|---|
| Input | Coordinates of vertices (9 | Σ, o, μ, c |
| | FP values) | |
| Pipeline levels | Coordinate shift (ADD, | Coordinate shift (ADD, |
| B and C | MULTIPLY) | MULTIPLY) |
| Pipeline levels | Intersection detection | Gaussian probability |
| D and E | (ADD, MULTIPLY, | distribution (ADD, |
| | DIVIDE) | MULTIPLY, EXPONENT) |
| Pipeline levels | UV weight computation | Color weight computation |
| F, G, and Ga | (ADD, MULTIPLY) | (ADD, MULTIPLY) |
| Pipeline levels | Minimum depth color hold | Color accumulation |
| Gb and H | ((ADD, MULTIPLY) | ((ADD, MULTIPLY) |
| Output | UV weight, depth (3 FP | Accumulated color value (3 |
| | values) | FP values) |

Each primitive type is associated with specific resource requirements at different pipeline levels. For example, at levels D-E the triangle rasterization utilizes a divider, while Gaussian rasterization utilizes an exponentiation unit. To accommodate these individualized resource constraints, the disclosed mechanisms utilize dedicated hardware units in a runtime-configurable hardware pipeline for both rasterization mechanisms.

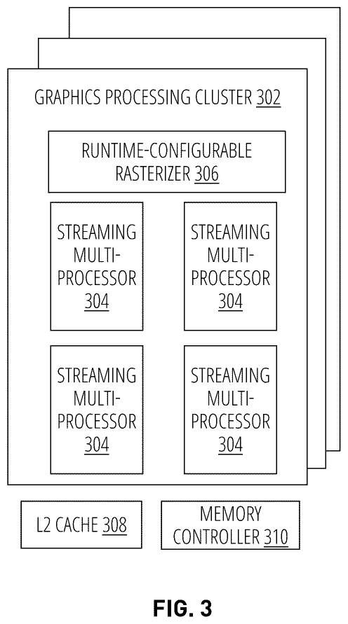

FIG. 3 depicts a graphics processing cluster at a high level, in accordance with one embodiment. The graphics processing cluster 302 comprises a plurality of streaming multi-processors 304 and a runtime-configurable rasterizer 306. The graphics processing cluster may comprise additional components as described below in conjunction with a specific graphics processing unit embodiment. The streaming multi-processors 304 of the graphics processing cluster 302 may utilize a level-2 cache 308 and a memory controller 310 in manners known in the art.

The streaming multi-processors 304 share access to the runtime-configurable rasterizer 306 for both triangular mesh rasterization and 3DGS rasterization. This mechanism enables seamless integration of 3DGS rasterization with conventional triangular mesh rasterization workflows with low additional hardware area and overhead.

The streaming multi-processors 304 comprise hardware for general-purpose computations and specialized fixed-function units for graphics processing. The runtime-configurable rasterizer 306 is configured to perform Gaussian splatting with a logic pipeline parallel in some stages to the conventional triangle rasterizer pipeline. The runtime-configurable rasterizer 306 comprises runtime switches 206 to select between traditional triangle rendering and Gaussian rasterization.

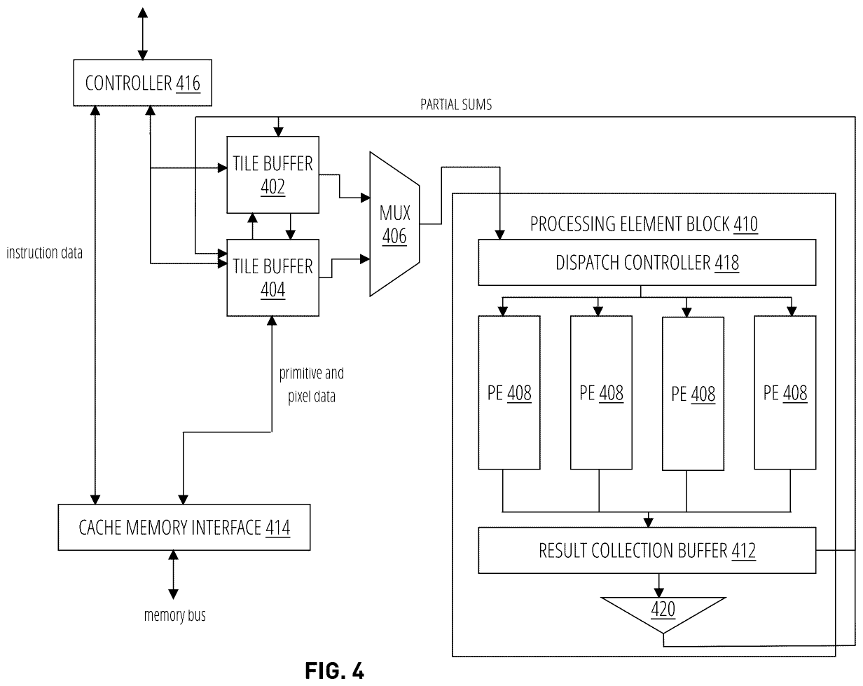

FIG. 4 depicts a runtime-configurable rasterizer 306 structure in more detail, in accordance with one embodiment.

The runtime-configurable rasterizer 306 in one embodiment comprises ping-pong tile buffers 402, 404 that store primitives (either Gaussians or triangles) and pixel data during the rendering process. By operating a selector 406 to alternate inputs from the tile buffers 402, 404 to the processing elements 408, the runtime-configurable rasterizer 306 reduces memory latency and enables concurrent access by the processing element block 410 to both Gaussian and triangle primitives.

Core computation of the rasterization process are handled by the processing element block 410 which comprises multiple processing elements 408. Each processing element 408 is enabled for processing either Gaussian or triangle primitives and output results to a result collection buffer 412. In one embodiment, the result collection buffer 412 may have a width of 9 32-bit floating point numbers, and a depth of 512. The processing element block 410 operates with a high degree of parallelism, leveraging the intrinsic parallel structure of the rendering task for acceleration.

Each processing element 408 comprises logic for both Gaussian and triangle rasterization and is equipped with a combination of shared and specialized logic units (i.e., Gaussian rasterizing logic 202 and triangle rasterizing logic 204). The shared logic performs operations common to both types of rasterization, while specialized logic performs primitive-specific computations, such as evaluating Gaussian probability distributions for 3DGS rendering and performing depth division for triangle meshes.

Compared to a conventional triangle rasterizer, the Gaussian rasterizing logic 202 of the runtime-configurable rasterizer 306 may, in one implementation, comprise two additional adders, one additional multiplier, and one exponentiation unit, while reusing nine adders and nine multipliers from the triangle rasterizing logic 204.

During a training mode, parameters of Gaussians are updated as the scene is being adjusted. The result collection buffer 412 first supplies values to the adder tree 420 for pre-computation. The adder tree 420 forwards the processed data to the tile buffers 402, 404, from which a Gaussian is fetched, and the accumulated data from adder tree 420 is added to the fetched data and the write back to the tile buffers 402, 404.

During an inference (rendering) mode, Gaussian features are accumulated into pixels. When operating in the inference mode, the result collection buffer 412 may supply values to the tile buffers 402, 404 to update the content of these buffers without any computation.

Therefor during both of training and inference modes, both of the result collection buffer 412 and the adder tree 420 may supply values to the tile buffers 402, 404.

The runtime-configurable rasterizer 306 may utilize the same cache memory interface 414, tile buffers 402, 404, top controller 416, and dispatch controller 418 for both triangle rasterization and Gaussian rasterization. This design ensures that the runtime-configurable rasterizer 306 remains compatible with conventional triangle rendering pipelines. During a rasterization process, each processing element 408 may be loaded with a pixel, after which multiple triangles or Gaussians are broadcast to all the processing elements 408 in the graphics processing cluster 302. Each processing element 408 selects a primitive to process and applies its features to the corresponding pixel.

By way of example, the dispatch controller 418 may manage a number P of pixels at a given iteration, while the tile buffers 402, 404 may store a number G of Gaussians at a time. During each iteration, the dispatch controller 418 may assign each processing element a pixel to process while the tile buffers 402, 404 supply Gaussians to the processing elements. The processing elements apply the received Gaussians to the assigned pixels. For example, using four processing elements, with P=256 and G=512, the pixels are computed over 256/4=64 iterations.

With graphics processing units from Nvidia® Corporation, CUDA cores and the triangle rasterizer may cooperate on triangle mesh rasterization workloads. Specifically, non-dominant tasks such as 3D-to-2D projection and color querying may be handled by CUDA cores, while the triangle rasterization itself is managed by a hardware triangle rasterizer.

The disclosed mechanisms may utilize a similar hybrid workload execution strategy to enhance efficiency of 3DGS rendering, assigning non-dominant operations such as pre-processing (splatting 3D Gaussian balls to 2D Gaussian distributions) and splat sorting to the CUDA cores, while the runtime-configurable rasterizer 306 executed the dominant rasterization workload operations that form the primary bottleneck in 3DGS rendering.

Before rendering a scene, the scene itself is constructed. This process is known as reconstruction. During reconstruction, images or photos of the scene taken from specific viewpoints are applied to train or tune a scene representation comprised of Gaussian features. This helps ensure that the rendering process reproduces accurate images from those specific viewpoints.

Neural networks may be trained on the specific viewpoints, and due to their ability to generalize from their training, may accurately render not only for the viewpoints trained upon, but also for viewpoints that the neural networks were not trained on. In practice, neural networks often succeed in generating correct images from viewpoints that were not provided during training.

A scene is represented initially by a set of randomized Gaussian balls. During the reconstruction process, the location, shape, and color of these Gaussian balls are adjusted by the trained neural network according to the viewpoint to render, and then splatted.

The processing pipeline used during the reconstruction is essentially the inverse of the 3DGS rendering process. The 3DGS rendering process involves applying Gaussians to pixels and accumulating their features (e.g., colors) to determine the final color of each pixel. In this process, a single pixel may receive contributions from multiple Gaussians, and a single Gaussian may span multiple pixels.

The reconstruction pipeline leverages these relationships in reverse to optimize the 3D scene representation from a particular viewpoint. The reconstruction process begins with determination of a loss function that compares rendered pixel values with the ground truth. This loss function serves as the basis for determining the gradients that guide the adjustment of Gaussian features, such as position, shape, and color. Pixel-wise color gradients (derived from the loss function) are distributed back to the corresponding Gaussians, taking into account the influence of each Gaussian on a pixel during rendering.

The gradients from all pixels that each Gaussian influences are aggregated. This is done because a single Gaussian contributes to multiple pixels, and during the reconstruction process, it must adjust its properties based on the combined influence of all these pixels. For this aggregation, a sum operation is used to collect and aggregate the gradients from all affected pixels, helping to ensure that the Gaussian updates are consistent with the tuning requests from different pixels in the entire scene.

Once the aggregated gradients are obtained, they are mapped back to the corresponding Gaussians to ensure that the updates are properly attributed to the correct Gaussians. This mapping step prepares the gradients for propagation in the final stage of the reconstruction pipeline, during which the aggregated 2D gradients are propagated back into the 3D Gaussian representations. This final stage adjusts the 3D properties of the Gaussians-such as their positions, sizes, and colors-based on the accumulated feedback from the 2D gradients. By iteratively performing these steps, the reconstruction pipeline refines the 3D Gaussian ball representation of the scene to better match the input images, thereby improving the quality of the images that will be rendered from the 3D Gaussians.

The processing element block 410 may in one embodiment comprise an adder tree 420 to improve the performance and/or computational efficiency of aggregating the pixel gradients for each Gaussian. A pipelined adder tree may be utilized to gather gradient data, enabling fast local reduction during training. An example of such an adder tree 420 for use with four processing elements 408 is depicted in FIG. 5. During reconstruction, all the processing elements 408 in a processing element block 410 may process the same Gaussian at a given time. After the processing elements 408 compute the gradient for the Gaussian, the adder tree 420 may aggregate the gradients for that Gaussian efficiently.

During the process of training a neural network for 3D Gaussian splatting, numerous data reductions occur, many of which are forwarded to the atomic computing cores in the level-2 cache 308. Conventional atomic units are insufficient for handling these operations, as memory throttling dominates the kernel runtime.

The mechanisms disclosed herein may be implemented in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. For example, the general processing clusters 702 of a graphics processing unit may be configured with runtime-configurable rasterizers in accordance with the embodiments disclosed herein. Exemplary architectures will now be described that may be configured with these mechanisms.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

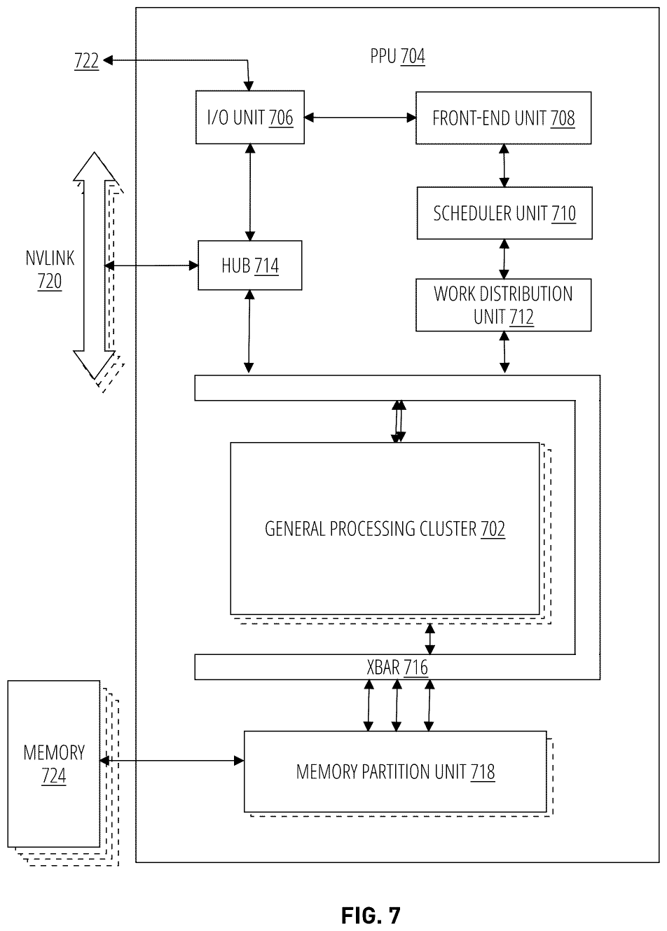

FIG. 7 depicts a parallel processing unit 704, in accordance with an embodiment. In an embodiment, the parallel processing unit 704 is a multi-threaded processor that is implemented on one or more integrated circuit devices. The parallel processing unit 704 is a latency hiding architecture designed to process many threads in parallel. A thread (e.g., a thread of execution) is an instantiation of a set of instructions configured to be executed by the parallel processing unit 704. In an embodiment, the parallel processing unit 704 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 704 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 704 modules may be configured to accelerate thousands of High Performance Computing (HPC), data center, and machine learning applications. The parallel processing unit 704 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 7, the parallel processing unit 704 includes an I/O unit 706, a front-end unit 708, a scheduler unit 710, a work distribution unit 712, a hub 714, a crossbar 716, one or more general processing cluster 702 modules, and one or more memory partition unit 718 modules. The parallel processing unit 704 may be connected to a host processor or other parallel processing unit 704 modules via one or more high-speed NVLink 720 interconnects. The parallel processing unit 704 may be connected to a host processor or other peripheral devices via an interconnect 722. The parallel processing unit 704 may also be connected to a local memory comprising a number of memory 724 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 724 may comprise logic to configure the parallel processing unit 704 to carry out aspects of the techniques disclosed herein.

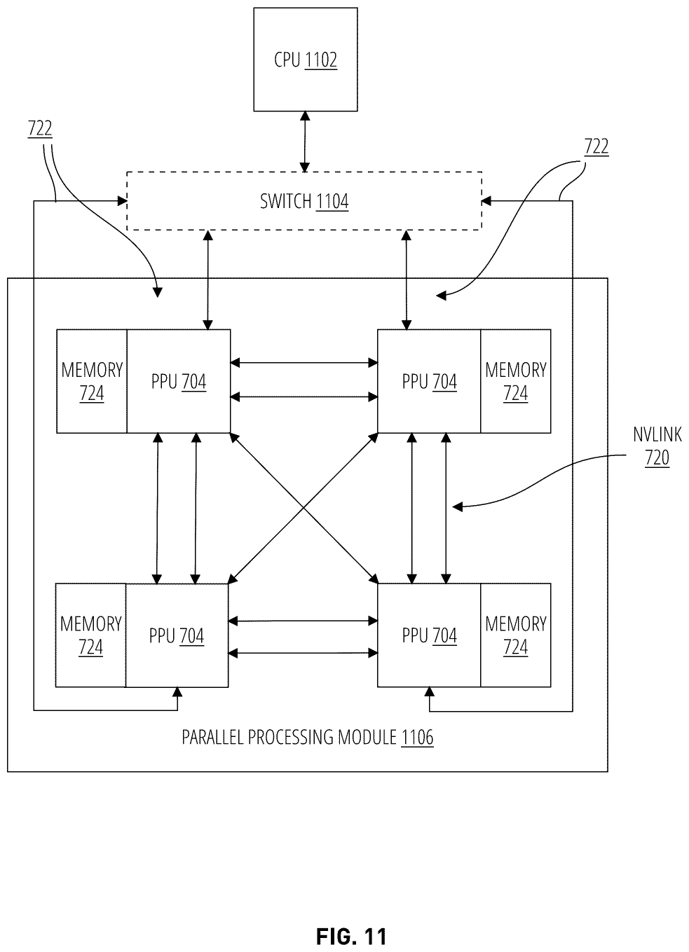

The NVLink 720 interconnect enables systems to scale and include one or more parallel processing unit 704 modules combined with one or more CPUs, supports cache coherence between the parallel processing unit 704 modules and CPUs, and CPU mastering. Data and/or commands may be transmitted by the NVLink 720 through the hub 714 to/from other units of the parallel processing unit 704 such as one or more copy engines, a video encoder, a video decoder, a power management unit, etc. (not explicitly shown). The NVLink 720 is described in more detail in conjunction with FIG. 11.

The I/O unit 706 is configured to transmit and receive communications (e.g., commands, data, etc.) from a host processor (not shown) over the interconnect 722. The I/O unit 706 may communicate with the host processor directly via the interconnect 722 or through one or more intermediate devices such as a memory bridge. In an embodiment, the I/O unit 706 may communicate with one or more other processors, such as one or more parallel processing unit 704 modules via the interconnect 722. In an embodiment, the I/O unit 706 implements a Peripheral Component Interconnect Express (PCIe) interface for communications over a PCIe bus and the interconnect 722 is a PCIe bus. In alternative embodiments, the I/O unit 706 may implement other types of well-known interfaces for communicating with external devices.

The I/O unit 706 decodes packets received via the interconnect 722. In an embodiment, the packets represent commands configured to cause the parallel processing unit 704 to perform various operations. The I/O unit 706 transmits the decoded commands to various other units of the parallel processing unit 704 as the commands may specify. For example, some commands may be transmitted to the front-end unit 708. Other commands may be transmitted to the hub 714 or other units of the parallel processing unit 704 such as one or more copy engines, a video encoder, a video decoder, a power management unit, etc. (not explicitly shown). In other words, the I/O unit 706 is configured to route communications between and among the various logical units of the parallel processing unit 704.

In an embodiment, a program executed by the host processor encodes a command stream in a buffer that provides workloads to the parallel processing unit 704 for processing. A workload may comprise several instructions and data to be processed by those instructions. The buffer is a region in a memory that is accessible (e.g., read/write) by both the host processor and the parallel processing unit 704. For example, the I/O unit 706 may be configured to access the buffer in a system memory connected to the interconnect 722 via memory requests transmitted over the interconnect 722. In an embodiment, the host processor writes the command stream to the buffer and then transmits a pointer to the start of the command stream to the parallel processing unit 704. The front-end unit 708 receives pointers to one or more command streams. The front-end unit 708 manages the one or more streams, reading commands from the streams and forwarding commands to the various units of the parallel processing unit 704.

The front-end unit 708 is coupled to a scheduler unit 710 that configures the various general processing cluster 702 modules to process tasks defined by the one or more streams. The scheduler unit 710 is configured to track state information related to the various tasks managed by the scheduler unit 710. The state may indicate which general processing cluster 702 a task is assigned to, whether the task is active or inactive, a priority level associated with the task, and so forth. The scheduler unit 710 manages the execution of a plurality of tasks on the one or more general processing cluster 702 modules.

The scheduler unit 710 is coupled to a work distribution unit 712 that is configured to dispatch tasks for execution on the general processing cluster 702 modules. The work distribution unit 712 may track a number of scheduled tasks received from the scheduler unit 710. In an embodiment, the work distribution unit 712 manages a pending task pool and an active task pool for each of the general processing cluster 702 modules. The pending task pool may comprise a number of slots (e.g., 32 slots) that contain tasks assigned to be processed by a particular general processing cluster 702. The active task pool may comprise a number of slots (e.g., 4 slots) for tasks that are actively being processed by the general processing cluster 702 modules. As a general processing cluster 702 finishes the execution of a task, that task is evicted from the active task pool for the general processing cluster 702 and one of the other tasks from the pending task pool is selected and scheduled for execution on the general processing cluster 702. If an active task has been idle on the general processing cluster 702, such as while waiting for a data dependency to be resolved, then the active task may be evicted from the general processing cluster 702 and returned to the pending task pool while another task in the pending task pool is selected and scheduled for execution on the general processing cluster 702.

The work distribution unit 712 communicates with the one or more general processing cluster 702 modules via crossbar 716. The crossbar 716 is an interconnect network that couples many of the units of the parallel processing unit 704 to other units of the parallel processing unit 704. For example, the crossbar 716 may be configured to couple the work distribution unit 712 to a particular general processing cluster 702. Although not shown explicitly, one or more other units of the parallel processing unit 704 may also be connected to the crossbar 716 via the hub 714.

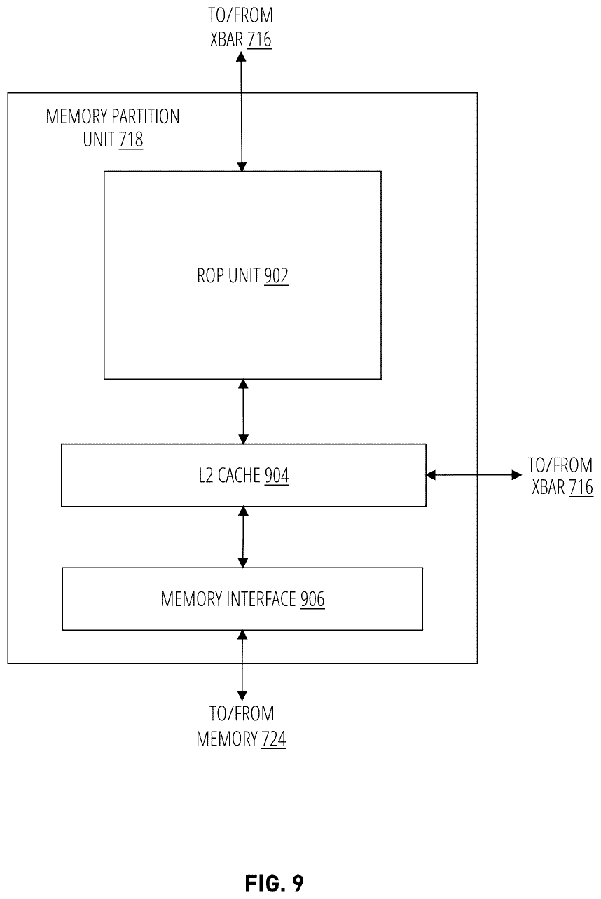

The tasks are managed by the scheduler unit 710 and dispatched to a general processing cluster 702 by the work distribution unit 712. The general processing cluster 702 is configured to process the task and generate results. The results may be consumed by other tasks within the general processing cluster 702, routed to a different general processing cluster 702 via the crossbar 716, or stored in the memory 724. The results can be written to the memory 724 via the memory partition unit 718 modules, which implement a memory interface for reading and writing data to/from the memory 724. The results can be transmitted to another parallel processing unit 704 or CPU via the NVLink 720. In an embodiment, the parallel processing unit 704 includes a number U of memory partition unit 718 modules that is equal to the number of separate and distinct memory 724 devices coupled to the parallel processing unit 704. A memory partition unit 718 will be described in more detail below in conjunction with FIG. 9.

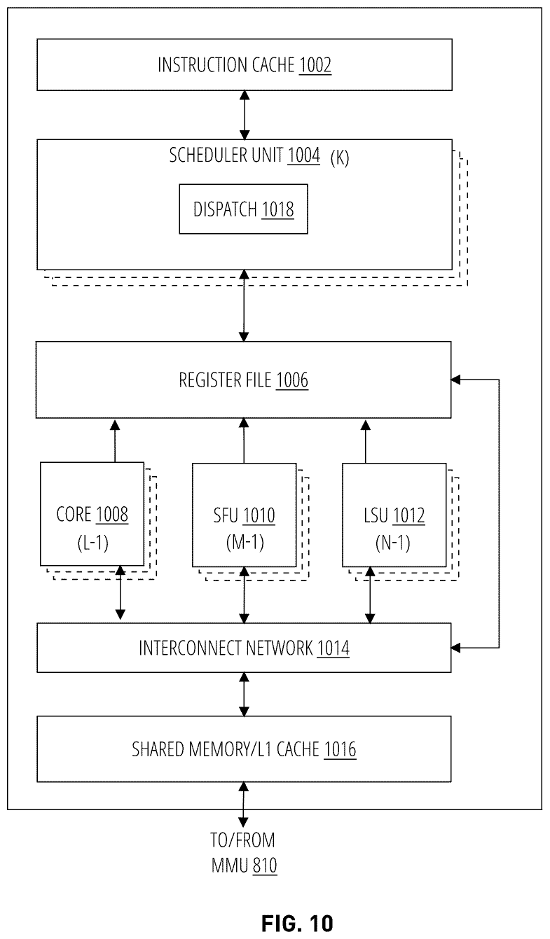

In an embodiment, a host processor executes a driver kernel that implements an application programming interface (API) that enables one or more applications executing on the host processor to schedule operations for execution on the parallel processing unit 704. In an embodiment, multiple compute applications are simultaneously executed by the parallel processing unit 704 and the parallel processing unit 704 provides isolation, quality of service (QoS), and independent address spaces for the multiple compute applications. An application may generate instructions (e.g., API calls) that cause the driver kernel to generate one or more tasks for execution by the parallel processing unit 704. The driver kernel outputs tasks to one or more streams being processed by the parallel processing unit 704. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 10.

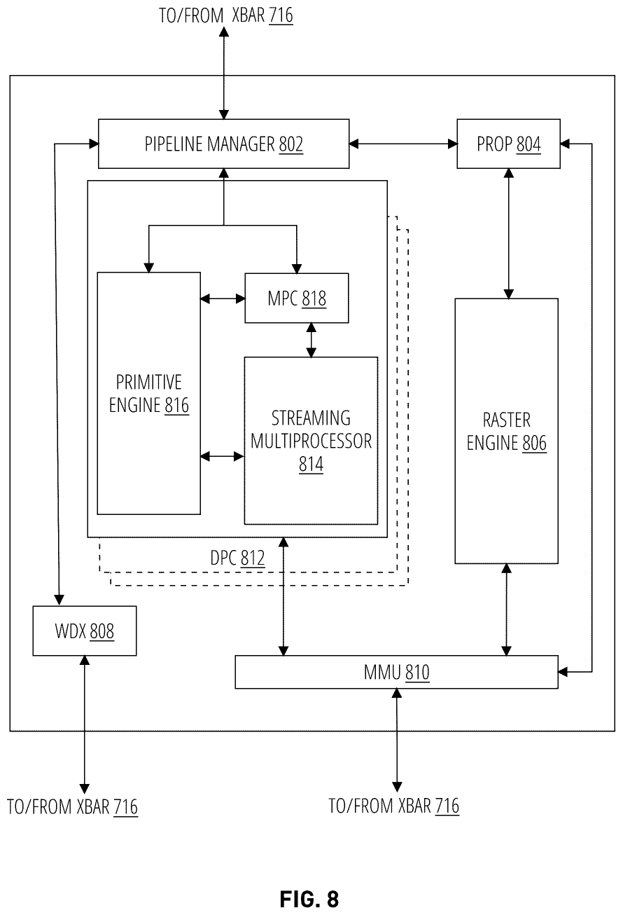

FIG. 8 depicts a general processing cluster 702 of the parallel processing unit 704 of FIG. 7, in accordance with an embodiment. As shown in FIG. 8, each general processing cluster 702 includes a number of hardware units for processing tasks. In an embodiment, each general processing cluster 702 includes a pipeline manager 802, a pre-raster operations unit 804, a raster engine 806, a work distribution crossbar 808, a memory management unit 810, and one or more data processing cluster 812. It will be appreciated that the general processing cluster 702 of FIG. 8 may include other hardware units in lieu of or in addition to the units shown in FIG. 8.

In an embodiment, the operation of the general processing cluster 702 is controlled by the pipeline manager 802. The pipeline manager 802 manages the configuration of the one or more data processing cluster 812 modules for processing tasks allocated to the general processing cluster 702. In an embodiment, the pipeline manager 802 may configure at least one of the one or more data processing cluster 812 modules to implement at least a portion of a graphics rendering pipeline. For example, a data processing cluster 812 may be configured to execute a vertex shader program on the programmable streaming multiprocessor 814. The pipeline manager 802 may also be configured to route packets received from the work distribution unit 712 to the appropriate logical units within the general processing cluster 702. For example, some packets may be routed to fixed function hardware units in the pre-raster operations unit 804 and/or raster engine 806 while other packets may be routed to the data processing cluster 812 modules for processing by the primitive engine 816 or the streaming multiprocessor 814. In an embodiment, the pipeline manager 802 may configure at least one of the one or more data processing cluster 812 modules to implement a neural network model and/or a computing pipeline.

The pre-raster operations unit 804 is configured to route data generated by the raster engine 806 and the data processing cluster 812 modules to a Raster Operations (ROP) unit, described in more detail in conjunction with FIG. 9. The pre-raster operations unit 804 may also be configured to perform optimizations for color blending, organize pixel data, perform address translations, and the like.

The raster engine 806 includes a number of fixed function hardware units configured to perform various raster operations. In an embodiment, the raster engine 806 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 806 comprises fragments to be processed, for example, by a fragment shader implemented within a data processing cluster 812.

Each data processing cluster 812 included in the general processing cluster 702 includes an M-pipe controller 818, a primitive engine 816, and one or more streaming multiprocessor 814 modules. The M-pipe controller 818 controls the operation of the data processing cluster 812, routing packets received from the pipeline manager 802 to the appropriate units in the data processing cluster 812. For example, packets associated with a vertex may be routed to the primitive engine 816, which is configured to fetch vertex attributes associated with the vertex from the memory 724. In contrast, packets associated with a shader program may be transmitted to the streaming multiprocessor 814.

The streaming multiprocessor 814 comprises a programmable streaming processor that is configured to process tasks represented by a number of threads. Each streaming multiprocessor 814 is multi-threaded and configured to execute a plurality of threads (e.g., 32 threads) from a particular group of threads concurrently. In an embodiment, the streaming multiprocessor 814 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 814 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 814 will be described in more detail below in conjunction with FIG. 10.

The memory management unit 810 provides an interface between the general processing cluster 702 and the memory partition unit 718. The memory management unit 810 may provide translation of virtual addresses into physical addresses, memory protection, and arbitration of memory requests. In an embodiment, the memory management unit 810 provides one or more translation lookaside buffers (TLBs) for performing translation of virtual addresses into physical addresses in the memory 724.

FIG. 9 depicts a memory partition unit 718 of the parallel processing unit 704 of FIG. 7, in accordance with an embodiment. As shown in FIG. 9, the memory partition unit 718 includes a raster operations unit 902, a level two cache 904, and a memory interface 906. The memory interface 906 is coupled to the memory 724. Memory interface 906 may implement 32, 64, 128, 1024-bit data buses, or the like, for high-speed data transfer. In an embodiment, the parallel processing unit 704 incorporates U memory interface 906 modules, one memory interface 906 per pair of memory partition unit 718 modules, where each pair of memory partition unit 718 modules is connected to a corresponding memory 724 device. For example, parallel processing unit 704 may be connected to up to Y memory 724 devices, such as high bandwidth memory stacks or graphics double-data-rate, version 5, synchronous dynamic random access memory, or other types of persistent storage.

In an embodiment, the memory interface 906 implements an HBM2 memory interface and Y equals half U. In an embodiment, the HBM2 memory stacks are located on the same physical package as the parallel processing unit 704, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 724 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 704 modules process very large datasets and/or run applications for extended periods.

In an embodiment, the parallel processing unit 704 implements a multi-level memory hierarchy. In an embodiment, the memory partition unit 718 supports a unified memory to provide a single unified virtual address space for CPU and parallel processing unit 704 memory, enabling data sharing between virtual memory systems. In an embodiment the frequency of accesses by a parallel processing unit 704 to memory located on other processors is traced to ensure that memory pages are moved to the physical memory of the parallel processing unit 704 that is accessing the pages more frequently. In an embodiment, the NVLink 720 supports address translation services allowing the parallel processing unit 704 to directly access a CPU's page tables and providing full access to CPU memory by the parallel processing unit 704.

In an embodiment, copy engines transfer data between multiple parallel processing unit 704 modules or between parallel processing unit 704 modules and CPUs. The copy engines can generate page faults for addresses that are not mapped into the page tables. The memory partition unit 718 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 724 or other system memory may be fetched by the memory partition unit 718 and stored in the level two cache 904, which is located on-chip and is shared between the various general processing cluster 702 modules. As shown, each memory partition unit 718 includes a portion of the level two cache 904 associated with a corresponding memory 724 device. Lower level caches may then be implemented in various units within the general processing cluster 702 modules. For example, each of the streaming multiprocessor 814 modules may implement an L1 cache. The L1 cache is private memory that is dedicated to a particular streaming multiprocessor 814. Data from the level two cache 904 may be fetched and stored in each of the L1 caches for processing in the functional units of the streaming multiprocessor 814 modules. The level two cache 904 is coupled to the memory interface 906 and the crossbar 716.

The raster operations unit 902 performs graphics raster operations related to pixel color, such as color compression, pixel blending, and the like. The raster operations unit 902 also implements depth testing in conjunction with the raster engine 806, receiving a depth for a sample location associated with a pixel fragment from the culling engine of the raster engine 806. The depth is tested against a corresponding depth in a depth buffer for a sample location associated with the fragment. If the fragment passes the depth test for the sample location, then the raster operations unit 902 updates the depth buffer and transmits a result of the depth test to the raster engine 806. It will be appreciated that the number of partition memory partition unit 718 modules may be different than the number of general processing cluster 702 modules and, therefore, each raster operations unit 902 may be coupled to each of the general processing cluster 702 modules. The raster operations unit 902 tracks packets received from the different general processing cluster 702 modules and determines which general processing cluster 1 that a result generated by the raster operations unit 902 is routed to through the crossbar 716. Although the raster operations unit 902 is included within the memory partition unit 718 in FIG. 9, in other embodiment, the raster operations unit 902 may be outside of the memory partition unit 718. For example, the raster operations unit 902 may reside in the general processing cluster 702 or another unit.

FIG. 10 illustrates the streaming multiprocessor 814 of FIG. 8, in accordance with an embodiment. As shown in FIG. 10, the streaming multiprocessor 814 includes an instruction cache 1002, one or more scheduler unit 1004 modules (e.g., such as scheduler unit 710), a register file 1006, one or more processing core 1008 modules, one or more special function unit 1010 modules, one or more load/store unit 1012 modules, an interconnect network 1014, and a shared memory/L1 cache 1016.

As described above, the work distribution unit 712 dispatches tasks for execution on the general processing cluster 702 modules of the parallel processing unit 704. The tasks are allocated to a particular data processing cluster 812 within a general processing cluster 702 and, if the task is associated with a shader program, the task may be allocated to a streaming multiprocessor 814. The scheduler unit 710 receives the tasks from the work distribution unit 712 and manages instruction scheduling for one or more thread blocks assigned to the streaming multiprocessor 814. The scheduler unit 1004 schedules thread blocks for execution as warps of parallel threads, where each thread block is allocated at least one warp. In an embodiment, each warp executes 32 threads. The scheduler unit 1004 may manage a plurality of different thread blocks, allocating the warps to the different thread blocks and then dispatching instructions from the plurality of different cooperative groups to the various functional units (e.g., core 1008 modules, special function unit 1010 modules, and load/store unit 1012 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1018 unit is configured within the scheduler unit 1004 to transmit instructions to one or more of the functional units. In one embodiment, the scheduler unit 1004 includes two dispatch 1018 units that enable two different instructions from the same warp to be dispatched during each clock cycle. In alternative embodiments, each scheduler unit 1004 may include a single dispatch 1018 unit or additional dispatch 1018 units.

Each streaming multiprocessor 814 includes a register file 1006 that provides a set of registers for the functional units of the streaming multiprocessor 814. In an embodiment, the register file 1006 is divided between each of the functional units such that each functional unit is allocated a dedicated portion of the register file 1006. In another embodiment, the register file 1006 is divided between the different warps being executed by the streaming multiprocessor 814. The register file 1006 provides temporary storage for operands connected to the data paths of the functional units.

Each streaming multiprocessor 814 comprises L processing core 1008 modules. In an embodiment, the streaming multiprocessor 814 includes a large number (e.g., 128, etc.) of distinct processing core 1008 modules. Each core 1008 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1008 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1008 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 814 also comprises M special function unit 1010 modules that perform special functions (e.g., attribute evaluation, reciprocal square root, and the like). In an embodiment, the special function unit 1010 modules may include a tree traversal unit configured to traverse a hierarchical tree data structure. In an embodiment, the special function unit 1010 modules may include texture unit configured to perform texture map filtering operations. In an embodiment, the texture units are configured to load texture maps (e.g., a 2D array of texels) from the memory 724 and sample the texture maps to produce sampled texture values for use in shader programs executed by the streaming multiprocessor 814. In an embodiment, the texture maps are stored in the shared memory/L1 cache 1016. The texture units implement texture operations such as filtering operations using mip-maps (e.g., texture maps of varying levels of detail). In an embodiment, each streaming multiprocessor 814 includes two texture units.

Each streaming multiprocessor 814 also comprises N load/store unit 1012 modules that implement load and store operations between the shared memory/L1 cache 1016 and the register file 1006. Each streaming multiprocessor 814 includes an interconnect network 1014 that connects each of the functional units to the register file 1006 and the load/store unit 1012 to the register file 1006 and shared memory/L1 cache 1016. In an embodiment, the interconnect network 1014 is a crossbar that can be configured to connect any of the functional units to any of the registers in the register file 1006 and connect the load/store unit 1012 modules to the register file 1006 and memory locations in shared memory/L1 cache 1016.

The shared memory/L1 cache 1016 is an array of on-chip memory that allows for data storage and communication between the streaming multiprocessor 814 and the primitive engine 816 and between threads in the streaming multiprocessor 814. In an embodiment, the shared memory/L1 cache 1016 comprises 128 KB of storage capacity and is in the path from the streaming multiprocessor 814 to the memory partition unit 718. The shared memory/L1 cache 1016 can be used to cache reads and writes. One or more of the shared memory/L1 cache 1016, level two cache 904, and memory 724 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1016 enables the shared memory/L1 cache 1016 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 7, are bypassed, creating a much simpler programming model. In the general purpose parallel computation configuration, the work distribution unit 712 assigns and distributes blocks of threads directly to the data processing cluster 812 modules. The threads in a block execute the same program, using a unique thread ID in the calculation to ensure each thread generates unique results, using the streaming multiprocessor 814 to execute the program and perform calculations, shared memory/L1 cache 1016 to communicate between threads, and the load/store unit 1012 to read and write global memory through the shared memory/L1 cache 1016 and the memory partition unit 718. When configured for general purpose parallel computation, the streaming multiprocessor 814 can also write commands that the scheduler unit 710 can use to launch new work on the data processing cluster 812 modules.

The parallel processing unit 704 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 704 is embodied on a single semiconductor substrate. In another embodiment, the parallel processing unit 704 is included in a system-on-a-chip (SoC) along with one or more other devices such as additional parallel processing unit 704 modules, the memory 724, a reduced instruction set computer (RISC) CPU, a memory management unit (MMU), a digital-to-analog converter (DAC), and the like.

In an embodiment, the parallel processing unit 704 may be included on a graphics card that includes one or more memory devices. The graphics card may be configured to interface with a PCIe slot on a motherboard of a desktop computer. In yet another embodiment, the parallel processing unit 704 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 11 is a conceptual diagram of a processing system implemented using the parallel processing unit 704 of FIG. 7, in accordance with an embodiment. The processing system includes a central processing unit 1102, a switch 1104, and multiple parallel processing unit 704 modules each and respective memory 724 modules. The switch 1104 is depicted with dashed lines, indicating that it is optional in some embodiments.

The NVLink 720 provides high-speed communication links between each of the parallel processing unit 704 modules. Although a particular number of NVLink 720 and interconnect 722 connections are illustrated in FIG. 11, the number of connections to each parallel processing unit 704 and the central processing unit 1102 may vary. The switch 1104 interfaces between the interconnect 722 and the central processing unit 1102. The parallel processing unit 704 modules, memory 724 modules, and NVLink 720 connections may be situated on a single semiconductor platform to form a parallel processing module 1106. In an embodiment, the switch 1104 supports two or more protocols to interface between various different connections and/or links.

In another embodiment (not shown), the NVLink 720 provides one or more high-speed communication links between each of the parallel processing unit modules (parallel processing unit 704, parallel processing unit 704, parallel processing unit 704, and parallel processing unit 704) and the central processing unit 1102 and the switch 1104 (when present) interfaces between the interconnect 722 and each of the parallel processing unit modules. The parallel processing unit modules, memory 724 modules, and interconnect 722 may be situated on a single semiconductor platform to form a parallel processing module 1106. In yet another embodiment (not shown), the interconnect 722 provides one or more communication links between each of the parallel processing unit modules and the central processing unit 1102 and the switch 1104 interfaces between each of the parallel processing unit modules using the NVLink 720 to provide one or more high-speed communication links between the parallel processing unit modules. In another embodiment (not shown), the NVLink 720 provides one or more high-speed communication links between the parallel processing unit modules and the central processing unit 1102 through the switch 1104. In yet another embodiment (not shown), the interconnect 722 provides one or more communication links between each of the parallel processing unit modules directly. One or more of the NVLink 720 high-speed communication links may be implemented as a physical NVLink interconnect or either an on-chip or on-die interconnect using the same protocol as the NVLink 720.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1106 may be implemented as a circuit board substrate and each of the parallel processing unit modules and/or memory 724 modules may be packaged devices. In an embodiment, the central processing unit 1102, switch 1104, and the parallel processing module 1106 are situated on a single semiconductor platform.

In an embodiment, each parallel processing unit module includes six NVLink 720 interfaces (as shown in FIG. 11, five NVLink 720 interfaces are included for each parallel processing unit module). The NVLink 720 may be operated exclusively for PPU-to-PPU communication as shown in FIG. 11, or some combination of PPU-to-PPU and PPU-to-CPU, when the central processing unit 1102 also includes one or more NVLink 720 interfaces.

In an embodiment, the NVLink 720 allows direct load/store/atomic access from the central processing unit 1102 to each parallel processing unit module's memory 724. In an embodiment, the NVLink 720 supports coherency operations, allowing data read from the memory 724 modules to be stored in the cache hierarchy of the central processing unit 1102, reducing cache access latency for the central processing unit 1102. In an embodiment, the NVLink 720 includes support for Address Translation Services (ATS), enabling the parallel processing unit module to directly access page tables within the central processing unit 1102. One or more of the NVLink 720 may also be configured to operate in a low-power mode.

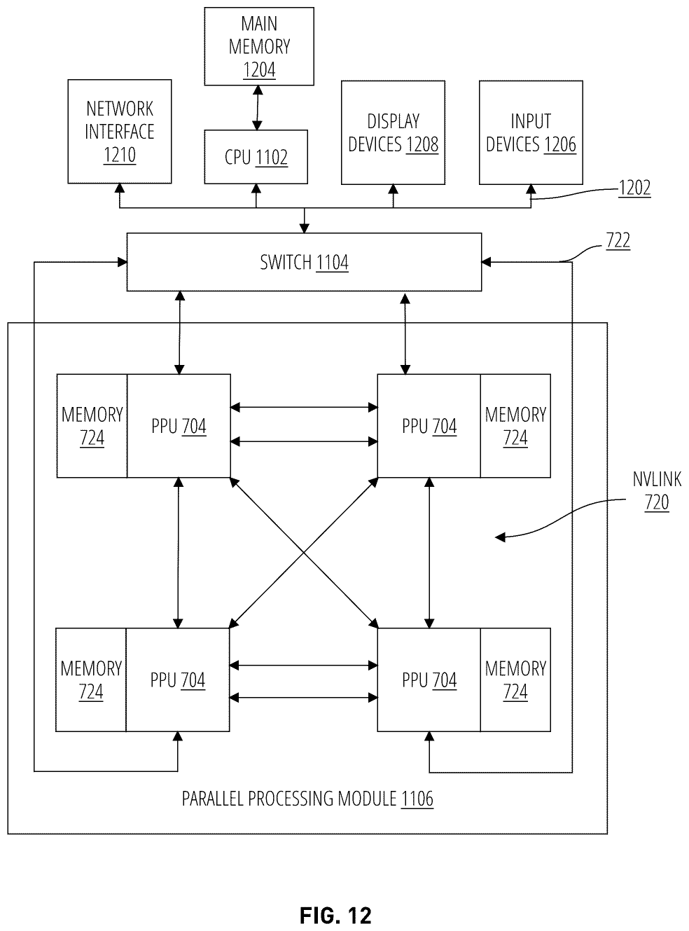

FIG. 12 depicts an exemplary processing system in which the various architecture and/or functionality of the various previous embodiments may be implemented. As shown, an exemplary processing system is provided including at least one central processing unit 1102 that is connected to a communications bus 1202. The communication communications bus 1202 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1204. Control logic (software) and data are stored in the main memory 1204 which may take the form of random access memory (RAM).

The exemplary processing system also includes input devices 1206, the parallel processing module 1106, and display devices 1208, e.g. a conventional CRT (cathode ray tube), LCD (liquid crystal display), LED (light emitting diode), plasma display or the like. User input may be received from the input devices 1206, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1210 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1204 and/or the secondary storage. Such computer programs, when executed, enable the exemplary processing system to perform various functions. The main memory 1204, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

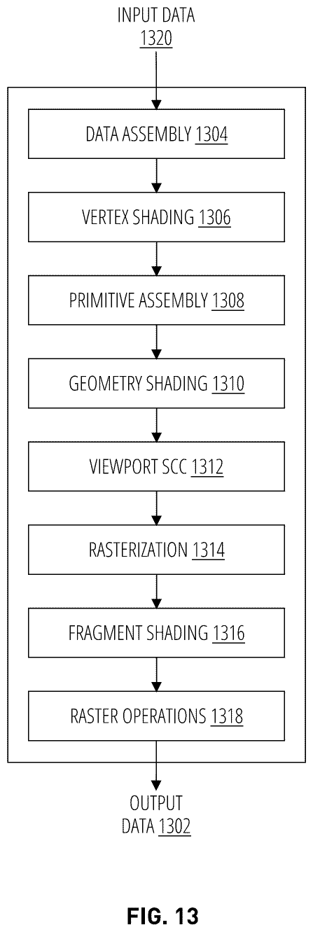

FIG. 13 is a conceptual diagram of a graphics processing pipeline implemented by the parallel processing unit 704 of FIG. 7, in accordance with an embodiment. In an embodiment, the parallel processing unit 704 comprises a graphics processing unit (GPU). The parallel processing unit 704 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 704 can be configured to process the graphics primitives to generate a frame buffer (e.g., pixel data for each of the pixels of the display).

An application writes model data for a scene (e.g., a collection of vertices and attributes) to a memory such as a system memory or memory 724. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 814 modules of the parallel processing unit 704 including one or more of a vertex shader, hull shader, domain shader, geometry shader, and a pixel shader. For example, one or more of the streaming multiprocessor 814 modules may be configured to execute a vertex shader program that processes a number of vertices defined by the model data. In an embodiment, the different streaming multiprocessor 814 modules may be configured to execute different shader programs concurrently. For example, a first subset of streaming multiprocessor 814 modules may be configured to execute a vertex shader program while a second subset of streaming multiprocessor 814 modules may be configured to execute a pixel shader program. The first subset of streaming multiprocessor 814 modules processes vertex data to produce processed vertex data and writes the processed vertex data to the level two cache 904 and/or the memory 724. After the processed vertex data is rasterized (e.g., transformed from three-dimensional data into two-dimensional data in screen space) to produce fragment data, the second subset of streaming multiprocessor 814 modules executes a pixel shader to produce processed fragment data, which is then blended with other processed fragment data and written to the frame buffer in memory 724. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline receives input data 601 that is transmitted from one stage to the next stage of the graphics processing pipeline to generate output data 1302. In an embodiment, the graphics processing pipeline may represent a graphics processing pipeline defined by the OpenGL® API. As an option, the graphics processing pipeline may be implemented in the context of the functionality and architecture of the previous Figures and/or any subsequent Figure(s).

As shown in FIG. 13, the graphics processing pipeline comprises a pipeline architecture that includes a number of stages. The stages include, but are not limited to, a data assembly 1304 stage, a vertex shading 1306 stage, a primitive assembly 1308 stage, a geometry shading 1310 stage, a viewport SCC 1312 stage, a rasterization 1314 stage, a fragment shading 1316 stage, and a raster operations 1318 stage. In an embodiment, the input data 1320 comprises commands that configure the processing units to implement the stages of the graphics processing pipeline and geometric primitives (e.g., points, lines, triangles, quads, triangle strips or fans, etc.) to be processed by the stages. The output data 1302 may comprise pixel data (e.g., color data) that is copied into a frame buffer or other type of surface data structure in a memory.

The data assembly 1304 stage receives the input data 1320 that specifies vertex data for high-order surfaces, primitives, or the like. The data assembly 1304 stage collects the vertex data in a temporary storage or queue, such as by receiving a command from the host processor that includes a pointer to a buffer in memory and reading the vertex data from the buffer. The vertex data is then transmitted to the vertex shading 1306 stage for processing.

The vertex shading 1306 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1306 stage may manipulate individual vertex attributes such as position, color, texture coordinates, and the like. In other words, the vertex shading 1306 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1306 stage generates transformed vertex data that is transmitted to the primitive assembly 1308 stage.

The primitive assembly 1308 stage collects vertices output by the vertex shading 1306 stage and groups the vertices into geometric primitives for processing by the geometry shading 1310 stage. For example, the primitive assembly 1308 stage may be configured to group every three consecutive vertices as a geometric primitive (e.g., a triangle) for transmission to the geometry shading 1310 stage. In some embodiments, specific vertices may be reused for consecutive geometric primitives (e.g., two consecutive triangles in a triangle strip may share two vertices). The primitive assembly 1308 stage transmits geometric primitives (e.g., a collection of associated vertices) to the geometry shading 1310 stage.

The geometry shading 1310 stage processes geometric primitives by performing a set of operations (e.g., a geometry shader or program) on the geometric primitives. Tessellation operations may generate one or more geometric primitives from each geometric primitive. In other words, the geometry shading 1310 stage may subdivide each geometric primitive into a finer mesh of two or more geometric primitives for processing by the rest of the graphics processing pipeline. The geometry shading 1310 stage transmits geometric primitives to the viewport SCC 1312 stage.

In an embodiment, the graphics processing pipeline may operate within a streaming multiprocessor and the vertex shading 1306 stage, the primitive assembly 1308 stage, the geometry shading 1310 stage, the fragment shading 1316 stage, and/or hardware/software associated therewith, may sequentially perform processing operations. Once the sequential processing operations are complete, in an embodiment, the viewport SCC 1312 stage may utilize the data. In an embodiment, primitive data processed by one or more of the stages in the graphics processing pipeline may be written to a cache (e.g. L1 cache, a vertex cache, etc.). In this case, in an embodiment, the viewport SCC 1312 stage may access the data in the cache. In an embodiment, the viewport SCC 1312 stage and the rasterization 1314 stage are implemented as fixed function circuitry.

The viewport SCC 1312 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1314 stage.

The rasterization 1314 stage converts the 3D geometric primitives into 2D fragments (e.g. capable of being utilized for display, etc.). The rasterization 1314 stage may be configured to utilize the vertices of the geometric primitives to setup a set of plane equations from which various attributes can be interpolated. The rasterization 1314 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1314 stage generates fragment data (e.g., interpolated vertex attributes associated with a particular sample location for each covered pixel) that are transmitted to the fragment shading 1316 stage.

The fragment shading 1316 stage processes fragment data by performing a set of operations (e.g., a fragment shader or a program) on each of the fragments. The fragment shading 1316 stage may generate pixel data (e.g., color values) for the fragment such as by performing lighting operations or sampling texture maps using interpolated texture coordinates for the fragment. The fragment shading 1316 stage generates pixel data that is transmitted to the raster operations 1318 stage.

The raster operations 1318 stage may perform various operations on the pixel data such as performing alpha tests, stencil tests, and blending the pixel data with other pixel data corresponding to other fragments associated with the pixel. When the raster operations 1318 stage has finished processing the pixel data (e.g., the output data 1302), the pixel data may be written to a render target such as a frame buffer, a color buffer, or the like.

It will be appreciated that one or more additional stages may be included in the graphics processing pipeline in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1310 stage). Other types of graphics processing pipelines are contemplated as being within the scope of the present disclosure. Furthermore, any of the stages of the graphics processing pipeline may be implemented by one or more dedicated hardware units within a graphics processor such as parallel processing unit 704. Other stages of the graphics processing pipeline may be implemented by programmable hardware units such as the streaming multiprocessor 814 of the parallel processing unit 704.

The graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 704. The API provides an abstraction for a programmer that lets a programmer utilize specialized graphics hardware, such as the parallel processing unit 704, to generate the graphical data without requiring the programmer to utilize the specific instruction set for the parallel processing unit 704. The application may include an API call that is routed to the device driver for the parallel processing unit 704. The device driver interprets the API call and performs various operations to respond to the API call. In some instances, the device driver may perform operations by executing instructions on the CPU. In other instances, the device driver may perform operations, at least in part, by launching operations on the parallel processing unit 704 utilizing an input/output interface between the CPU and the parallel processing unit 704. In an embodiment, the device driver is configured to implement the graphics processing pipeline utilizing the hardware of the parallel processing unit 704.

Various programs may be executed within the parallel processing unit 704 in order to implement the various stages of the graphics processing pipeline. For example, the device driver may launch a kernel on the parallel processing unit 704 to perform the vertex shading 1306 stage on one streaming multiprocessor 814 (or multiple streaming multiprocessor 814 modules). The device driver (or the initial kernel executed by the parallel processing unit 704) may also launch other kernels on the parallel processing unit 704 to perform other stages of the graphics processing pipeline, such as the geometry shading 1310 stage and the fragment shading 1316 stage. In addition, some of the stages of the graphics processing pipeline may be implemented on fixed unit hardware such as a rasterizer or a data assembler implemented within the parallel processing unit 704. It will be appreciated that results from one kernel may be processed by one or more intervening fixed function hardware units before being processed by a subsequent kernel on a streaming multiprocessor 814.

LISTING OF DRAWING ELEMENTS
102 3D Gaussian ball
104 pixel plane
106 2D Gaussian distribution
108 output pixel
110 scene representation
202 Gaussian rasterizing logic
204 triangle rasterizing logic
206 runtime switch
302 graphics processing cluster
304 streaming multi-processor
306 runtime-configurable rasterizer
308 level-2 cache
310 memory controller
402 tile buffer
404 tile buffer
406 selector
408 processing element
410 processing element block
412 result collection buffer
414 cache memory interface
416 controller
418 dispatch controller
420 adder tree
502 processing element
702 general processing cluster
704 parallel processing unit
706 I/O unit
708 front-end unit
710 scheduler unit
712 work distribution unit
714 hub
716 crossbar
718 memory partition unit
720 NVLink
722 interconnect
724 memory
802 pipeline manager
804 pre-raster operations unit
806 raster engine
808 work distribution crossbar
810 memory management unit
812 data processing cluster
814 streaming multiprocessor
816 primitive engine
818 M-pipe controller
902 raster operations unit
904 level two cache
906 memory interface
1002 instruction cache
1004 scheduler unit
1006 register file
1008 core
1010 special function unit
1012 load/store unit
1014 interconnect network
1016 shared memory/L1 cache
1018 dispatch
1102 central processing unit
1104 switch
1106 parallel processing module
1202 communications bus
1204 main memory
1206 input devices
1208 display devices
1210 network interface
1302 output data
1304 data assembly
1306 vertex shading
1308 primitive assembly
1310 geometry shading
1312 viewport SCC
1314 rasterization
1316 fragment shading
1318 raster operations
1320 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C. § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A rasterizer comprising:
a plurality of processing elements each comprising:
logic specific to triangle rasterization;
logic specific to Gaussian rasterization;
logic common to both of the triangle rasterization and the Gaussian rasterization; and
a runtime-activated selector to activate either the logic specific to triangle rasterization or the logic specific to Gaussian rasterization.

2. The rasterizer of claim 1, the logic common to both of the triangle rasterization and the Gaussian rasterization comprising:
a plurality of adders in a first rasterizer stage.

3. The rasterizer of claim 1, the logic specific to triangle rasterization comprising:
a plurality of adders in a first rasterizer stage.

4. The rasterizer of claim 1, the logic common to both of the triangle rasterization and the Gaussian rasterization comprising:
a plurality of multipliers in a second rasterizer stage.

5. The rasterizer of claim 1, the logic common to both of the triangle rasterization and the Gaussian rasterization comprising:
a plurality of adders in a third rasterizer stage.

6. The rasterizer of claim 1, the logic specific to triangle rasterization comprising:
an adder in a third rasterizer stage.

7. The rasterizer of claim 1, the logic specific to triangle rasterization comprising:
a divider in a fourth rasterizer stage.

8. The rasterizer of claim 1, the logic specific to Gaussian rasterization comprising:
an exponential circuit in a fourth rasterizer stage.

9. The rasterizer of claim 1, the logic common to both of the triangle rasterization and the Gaussian rasterization comprising:
an adder and a multiplier in a fifth rasterizer stage.

10. The rasterizer of claim 1, the logic specific to Gaussian rasterization comprising:
an adder in a fifth rasterizer stage.

11. The rasterizer of claim 1, the logic specific to Gaussian rasterization comprising:
a multiplier in a sixth rasterizer stage.

12. The rasterizer of claim 1, the logic specific to triangle rasterization comprising:
an adder in a sixth rasterizer stage.

13. The rasterizer of claim 1, the logic common to both of the triangle rasterization and the Gaussian rasterization comprising:
a plurality of multipliers in a seventh rasterizer stage.

14. The rasterizer of claim 1, the logic common to both of the triangle rasterization and the Gaussian rasterization comprising:
a plurality of adders in an eighth rasterizer stage.

15. A computer system comprising:
a plurality of data processors;
a rasterizer configured to be shared among the data processors, the rasterizer comprising:
logic specific to triangle rasterization;
logic specific to Gaussian rasterization;
logic common to both of the triangle rasterization and the Gaussian rasterization; and
a runtime-activated selector to activate either the logic specific to triangle rasterization or the logic specific to Gaussian rasterization.

16. The computer system of claim 15, the logic common to both of the triangle rasterization and the Gaussian rasterization comprising:
a plurality of adders in a first rasterizer stage.

17. The computer system of claim 15, the logic specific to triangle rasterization comprising:
a plurality of adders in a first rasterizer stage.

18. The computer system of claim 15, the logic common to both of the triangle rasterization and the Gaussian rasterization comprising:
a plurality of multipliers in a second rasterizer stage.

19. The computer system of claim 15, the logic common to both of the triangle rasterization and the Gaussian rasterization comprising:
a plurality of adders in a third rasterizer stage.

20. The computer system of claim 15, the logic specific to triangle rasterization comprising:
an adder in a third rasterizer stage.

21. The computer system of claim 15, the logic specific to triangle rasterization comprising:
a divider in a fourth rasterizer stage.

22. The computer system of claim 15, the logic specific to Gaussian rasterization comprising:
an exponential circuit in a fourth rasterizer stage.

23. A rasterizer comprising:
a plurality of processing elements each comprising:
logic specific to triangle rasterization;
logic specific to Gaussian rasterization;
logic common to both of the triangle rasterization and the Gaussian rasterization;
a runtime-activated selector to activate either the logic specific to triangle rasterization or the logic specific to Gaussian rasterization;
a buffer configured to collect outputs of the processing elements; and
an adder tree coupled between the buffer and inputs to the processing elements.
